(19) United States
(12) Patent Application Publication
(10) Pub. No.: US 2008/0127269 A1
(43) Pub. Date: May 29, 2008

(54) FIRST RUN NOTIFICATION OF A PRESENTATION

(76) Inventor: Christian Chicles, Orlando, FL (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/563,219

(22) Filed: Nov. 27, 2006

(51) Int. Cl. G06F 3/00

(52) U.S. Cl. 725/44

(57) ABSTRACT

First run notification of a presentation. An indicator on the network guide or recorded programs list would allow a user to quickly distinguish between first run presentations that have never before been available at an earlier time in the program guide and presentations that have been previously shown. The first run presentations could be distinguished by an indicator such as background color, a special icon, text color, or specific text.

### FIELD OF THE INVENTION

This invention relates in general to broadband communications systems, and more particularly, to the field of network multimedia systems having an interactive program guide.

### DESCRIPTION OF THE RELATED ART

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, and play back that recorded video as desired by the user. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Television has become so prevalent in the United States that the typical household may have two or more television sets, each television set requiring its own STT if the subscriber wishes to have access to enhanced functionality.

A networked multimedia system (NMS) is described in copending U.S. patent application Ser. No. 10/342,670, filed Jan. 15, 2003, the disclosure and teachings of which are hereby incorporated by reference. The NMS allows a plurality of remote devices in the premises to be locally networked (i.e., home-networked). One of the remote devices typically acts as the server or primary device (i.e., the primary set-top terminal (STT)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example. Additionally, the remote devices may independently receive presentations from and send upstream signals to the communications network. Accordingly, the remote devices may be simplified, less-costly versions of the primary device but are capable of utilizing, via the NMS, some or all of the advanced hardware and software features, such as memory, a mass storage device, software applications, or infrastructure for transmitting signals back to the headend, that are available in the primary device.

Subscription television systems typically include an interactive program guide (IPG) that can be accessed from both the primary device and remote devices 150-1 to 150-n. The IPG provides an onscreen display of a program grid menu that includes a program lineup and episode information for every channel for a specified number of days. The program grid menu may be arranged in various ways. The program grid menu itself is a user interface where the user may navigate the program grid menu using arrow keys on a remote. The user can navigate or scroll through the list of programs within the selected time slot until the desired program is highlighted. Once the desired field is highlighted as a selectable item, the user may select the highlighted field using the select button on the remote.

The program lineup and episode information in the IPG do not distinguish between program instances that have been previously aired and those that are showing for the first time. Therefore, there exists a need for a user to easily determine a first run program instance from a program instance that has previously been shown by the cable operators.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 illustrates a non-limiting example of one embodiment of an interactive program guide (IPG), which is suitable for use in the NMS of FIG. 1.

FIG. 3 illustrates the IPG of FIG. 2 displaying only first run program instances.

FIG. 4 illustrates the IPG of FIG. 2 displaying only first run program instances in a specific category.

FIG. 5 depicts a non-limiting example of a recorded programs list screen distinguishing first run presentations.

FIG. 6 depicts a non-limiting example of a recorded programs list screen distinguishing presentations that have been watched.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STT), a television, a computer, a personal digital assistant (PDA), or other display device. Moreover, in accordance with the present invention a multi-room interactive network guide can have various features, functions, and presentations when displayed. All examples given herein, therefore, are intended to be non-limiting and are provided in order to help clarify the description of the invention.

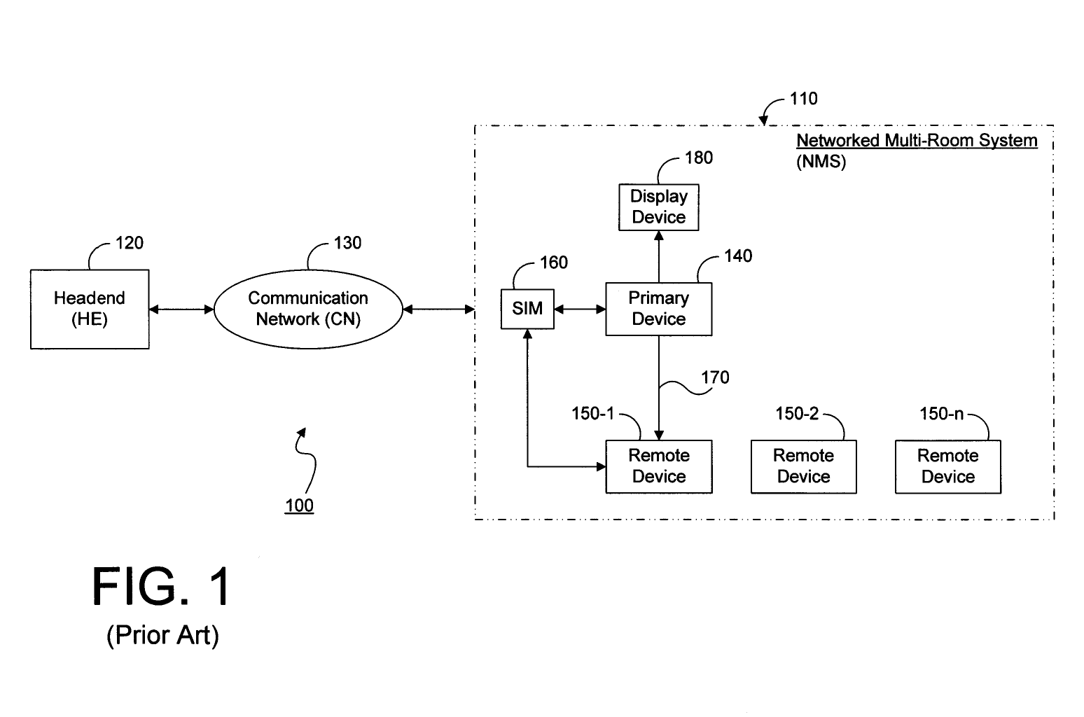

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. Alternatively, there could be a single primary device talking to the HE 120. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FTTH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times. Additionally, PPV services are typically transmitted to the primary device 140 at all times, but can only be viewed on the primary device 140 as provisioned. On the other hand, the primary device 140 typically requests a VOD service and, subsequently, the HE 120 transmits the presentation downstream to the primary device 140.

The NMS can include a router, but as shown in FIG. 1, the NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide to name but a few, to a coupled display device 180, which may be, for example, a television, computer, or PDA (personal digital assistant), among others. The primary device 140 may transmit signals to and receive control signals from the display device 180 via wireless devices (e.g., RF or IR devices) or a wired medium (e.g., coaxial cable, power lines, or telephone lines). It will also be appreciated that the primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 and just share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160. A preferred embodiment of the present invention uses a quadrature amplitude modulation (QAM) modulator, which may be used for effectively transmitting signals over coaxial cable in a cable television environment.

The presentations stored in the storage device of the primary device 140 include program identifiers (PIDs), which may be indexed and stored as a table in the primary device's memory. The remote devices 150-1 to 150-n may watch a single stored presentation by remapping the PID value of the stored program to a different PID value prior to modulation. In this manner, the single stored program basically remains in the storage device, while the transmitted presentation is a copy of the stored presentation having a remapped PID value.

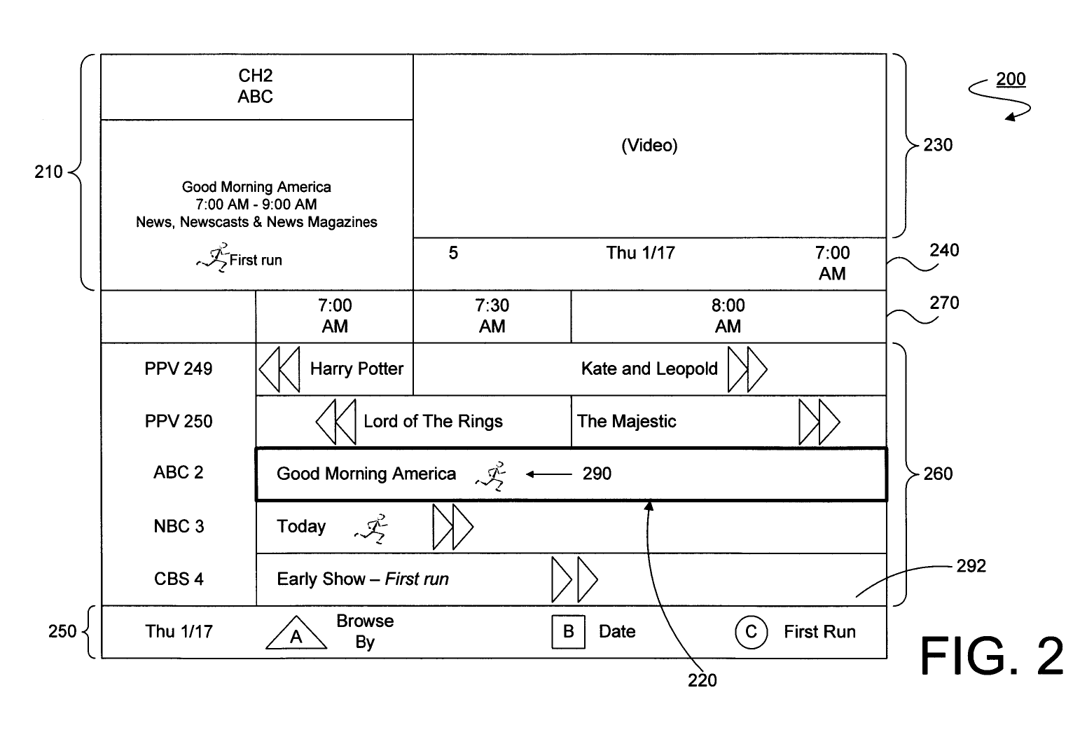

FIG. 2 illustrates a non-limiting example of an interactive program guide (IPG) screen 200 that is suitable for use in the NMS 110 of FIG. 1. The IPG screen 200 may be presented in response to user input that may be provided via the activation of a guide key on the remote control. In the top right of the IPG screen 200, video corresponding to the channel to which the primary device 140 is currently tuned may be displayed in the video screen 230. Immediately below the video area 230 is an information banner 240 for displaying the channel number corresponding to the channel to which the primary device 140 is currently tuned, the current day and date, and the current time.

The arrow buttons on the remote control can be used to scroll through a main presentation listing 260 and to highlight a desired presentation 220. The top left portion of the IPG screen 200 is a detailed focus area 210 that includes detailed information for a currently highlighted presentation 220. The detailed focus area 210 may include channel number, channel description, presentation name, duration of the presentation, and/or any episode information or rating. As a user scrolls in time across a calendar day boundary 270, the day and date indications displayed in various areas are updated. The bottom area 250 of the IPG screen 200 also indicates the current day for which presentation listing data is being displayed as well as information about the current functions of the optional “A,” “B,” and “C” keys that may be on the remote controls and are used in conjunction with the IPG. Further information regarding an interactive program guide can be found in copending U.S. patent application Ser. No. 10/212,017 filed on Aug. 2, 2002, the disclosure and teachings of which are hereby incorporated by reference.

When viewing the IPG 200, an indicator could be used to distinguish first run or previously unaired presentations from subsequent presentations of the same program instance such as those being shown for a second time, third time, etc. The cable operator could denote first run program instances when sending the program information to the HE 120 or STT. The HE 120 or STT would then use indicators to mark first run program instances. The indicator for first run presentations could be a background color, a special icon, text color, or specific text. If the indicator is color, the background of the presentation field of a first run presentation would appear a different color from the backgrounds of other program instances which are not first run presentations. Subsequent occurrences in the IPG 200 of a first run presentation would also have a different color from the first occurrence of the same presentation. The color could be standard or a preference the user can configure. For example, if the highlighted presentation 220 is a first run presentation, the background of the highlighted presentation 220 could appear yellow. The detailed focus area 210 would also have a yellow background corresponding to the highlighted presentation 220. The detailed focus area 210 would also have text stating that the program was a first run presentation.

In another embodiment, the indicator could be a special icon to distinguish a first run presentation from other subsequent occurrences of the same presentation or other previously aired presentations. For example in FIG. 2, the highlighted presentation 220 has an icon 290 placed after the title “Good Morning America.” The icon 290 could also be placed before the title. The icon 290 also appears in the detailed focus area 210 along with text stating that the program is a first run presentation. This information would also be available in the banner that appears when a user requests information about the presentation currently being viewed using the “Info” button on the remote control.

For the icon 290 to be displayed correctly, it could be added to the font character set used in the IPG 200 or it could be a graphic inserted or overlaid as a bitmap or jpeg file at the appropriate place. The icon 290 could be predetermined or chosen by the user from a database provided on the hard drive of the STT. It would also be possible for the user to create and insert their own icon by downloading an image from the internet, a personal computer, or a removable storage medium to the STT or alternatively to the HE 120.

In another embodiment, the indicator to distinguish a first run presentation could be text color. For example, in the highlighted presentation 220, without the icon 290, the text “Good Morning America” would appear in the color pink while the background is the standard color. The color of the text could be predetermined or chosen by the user.

In another embodiment, the indicator could be specific text used to distinguish a first run presentation from subsequent occurrences of the same presentation. When looking at the main presentation listing 260, a first run presentation would have the words “first run” displayed after the title of the presentation. For example, the presentation field 292 has the text “Early Show—first run.” The text would also appear in the detailed focus area 210 when the presentation was highlighted.

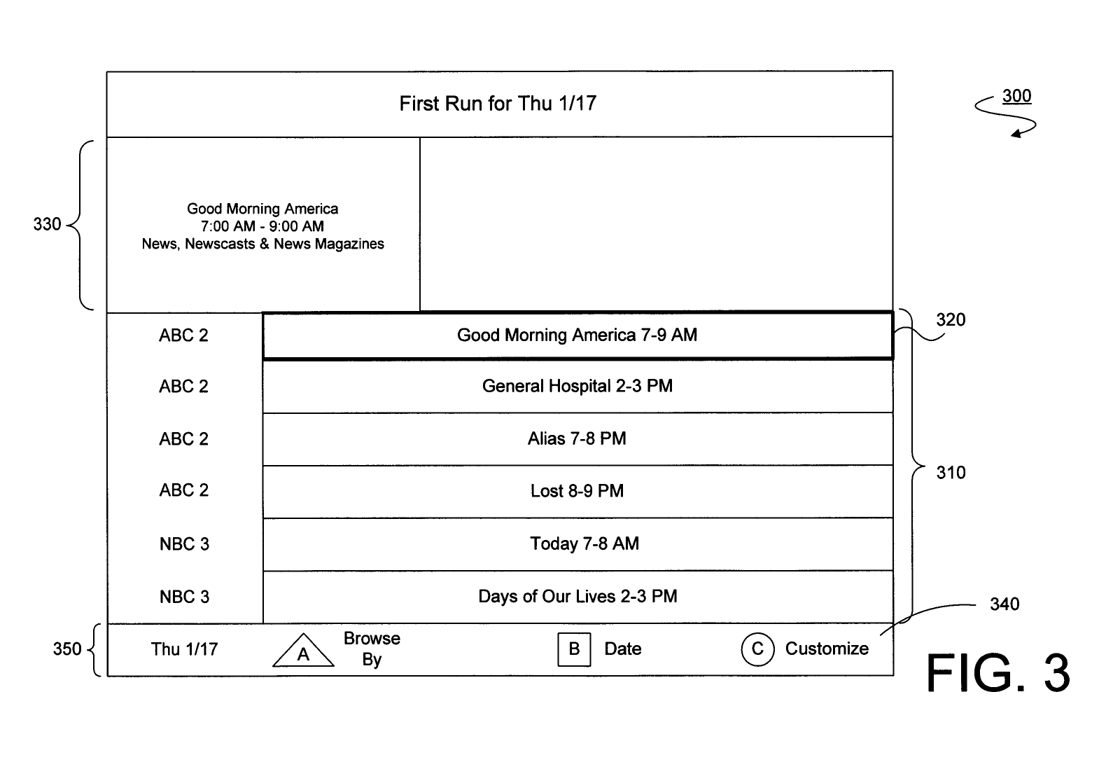

FIG. 3 depicts a non-limiting example of a first run programs list screen 300 showing only first run program instances for a specified time period. While viewing the IPG 200, a user could press the “C” button on a remote control which corresponds to the “C” button appearing on the IPG 200. The “C” button is labeled “First Run” and will prompt the first run programs list screen 300 to appear. The first run programs list screen 300 only displays the first run program instances for the specified time period, such as 24 hours. For example, first run programs list screen 300 shows that the chosen day is Thursday, January 17. The first run programs list 310 displays all of the first run program instances beginning with the earliest show on the lowest channel number. For example, the first program instance 320 is Good Morning America from 7-9 AM on ABC Channel 3. Once all of the first run program instances for Channel 3 have been displayed, then the first run program instances for Channel 4 are displayed. The first run programs list screen 300 could also display the program information in a grid pattern similar to FIG. 2.

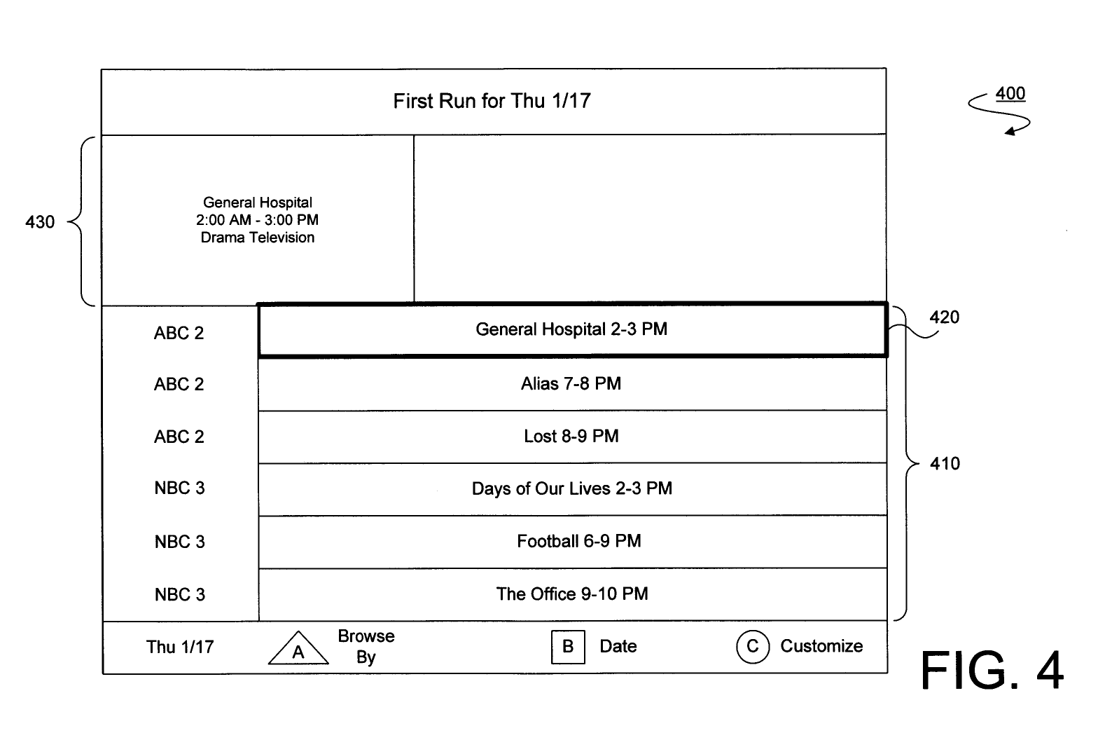

Each program instance has been categorized by the cable operator. The categories could include sports, news, drama, etc. The detailed focus area 330 displays the category associated with a highlighted program. For example, the highlighted program instance 320 is categorized as “News, Newscasts, & News Magazines.” The “C” button 340 on the bottom of the first run programs list screen 300 is labeled Customize. The Customize option will allow a user to customize the layout and content of the first run programs list screen 300. For example, the user could limit the first run programs list to only Sports Events. The user could also choose to exclude News, Newscasts, & News Magazines programs from the first run program list 310 as shown in FIG. 4.

FIG. 4 illustrates the first run programs list screen 300 displaying only first run program instances from specified categories. Some program categories, such as news have first run program instances every day and sometimes several times a day. This would cause the first run programs list 310 to be lengthy. There is an option for the user to customize the first run programs list 310 to only chosen categories. For example if News, Newscasts, & News Magazines programs have been excluded from the first run programs list 310, the first run programs list 310 will display first run programs in all categories except News, Newscasts, & News Magazines.

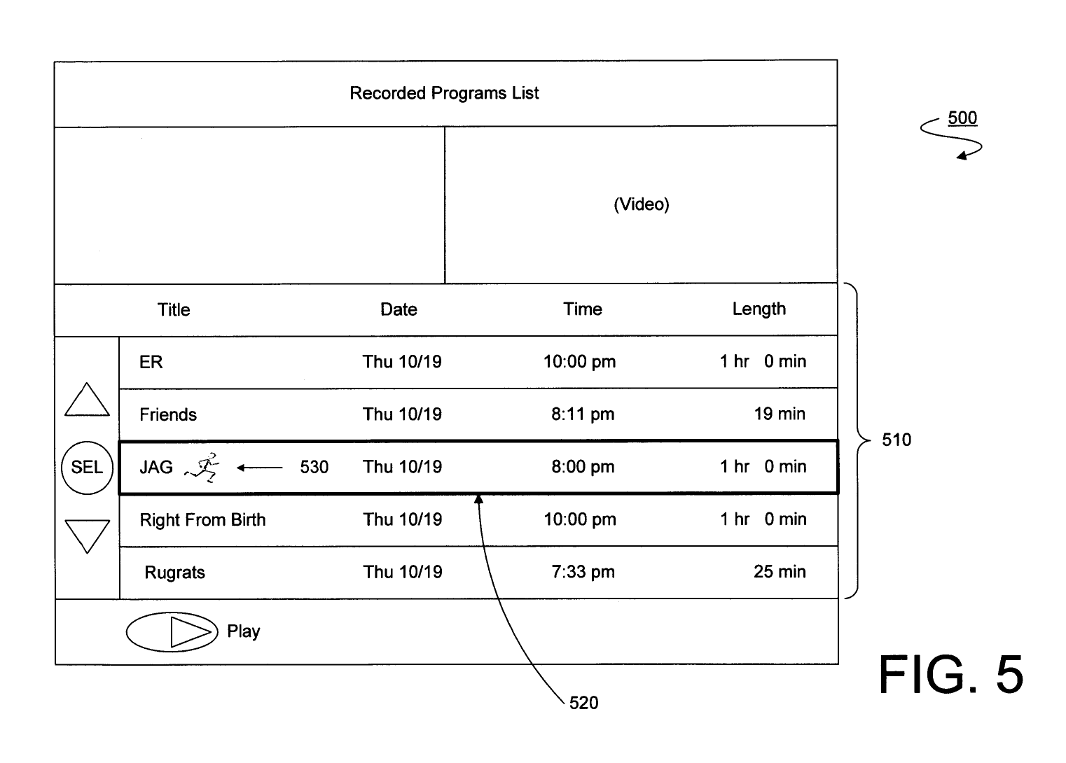

FIG. 5 depicts a non-limiting example of the interactive recorded programs list screen 500 showing a portion of a recorded programs list 510 that may be presented to a user of the NMS 110 of FIG. 1. The recorded programs list may be accessed by a specific button on the remote control or by entering the corresponding channel number. The recorded programs list screen 500 displays a list that includes all the recorded programs 510 showing, for example, the title, the recording date and time, and the length of the program. The recorded programs list could also display an indicator to distinguish first run presentations from subsequent occurrences of the same presentation. The indicator for first run presentations could be background color, a special icon, text color, or specific text. The user could choose which indicator would be displayed on the recorded programs list 500.

If background color is the chosen indicator, the background of the field containing the title, date, recording time, and length would be the specified color. For example, the highlighted presentation 520 could have a yellow background to signify a first run presentation. When a special icon is the indicator, the icon would appear immediately before or immediately after the title. For example, the highlighted presentation 520 has an icon 530 positioned to the right of the title “JAG.” The color of the text could also be used as an indicator. The text normally appears white, but could appear green for first run presentations. For example, in the highlighted presentation 520, the title “JAG”, the date “Thu October 19”, recording time “8:00 pm,” and length “1 hr 0 min” would all appear in green text. Specific text could also be used as the indicator. Text would be placed immediately after the title of the presentation stating “first run” in italics.

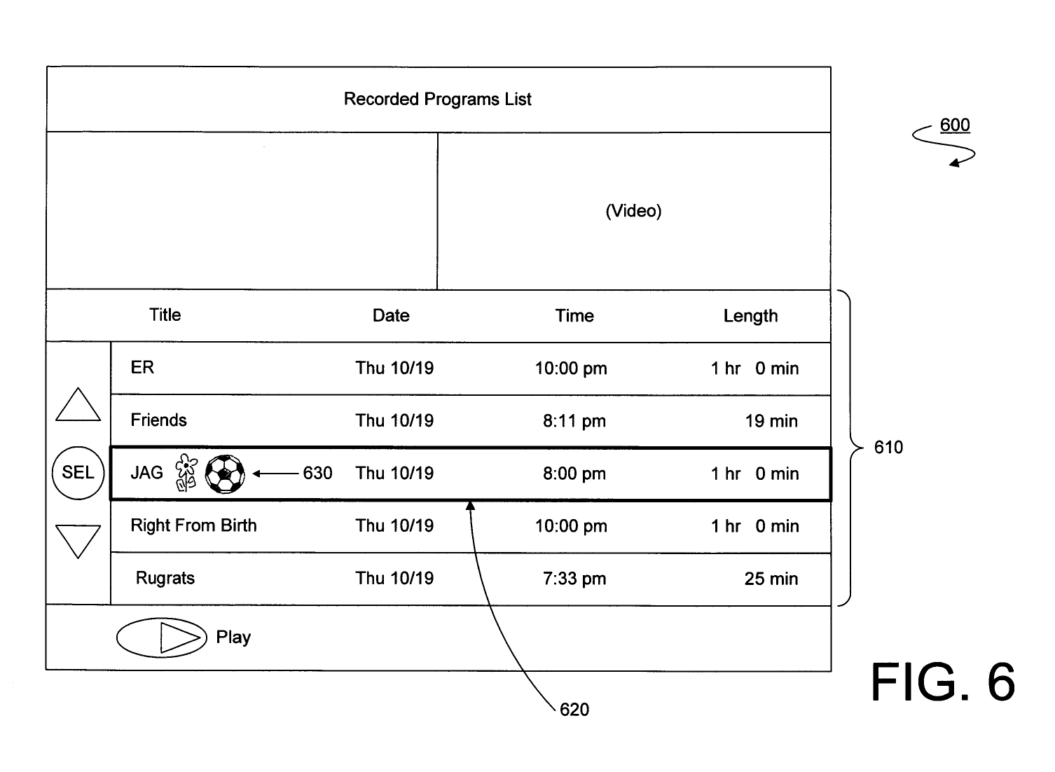

FIG. 6 depicts a non-limiting example of the interactive recorded programs list screen 600 showing a portion of a recorded programs list 610 that may be presented to a user of the NMS 110 of FIG. 1. The same indicators mentioned above could be used to distinguish between programs on the recorded programs list 610 that have been watched by a user and those that have not been viewed. One user in a household could tell at a glance if a second user had watched a program saved on the recorded programs list 610. This could be useful if more space was needed on the hard drive of the STT and a user wanted to delete programs or to monitor television viewing. In a home with only a primary device, the indicator could be background color, a special icon, text color, or specific text.

If background color is the chosen indicator, the background of the field containing the title, date, recording time, and length would be a specified color. For example, the highlighted presentation 620 could have a yellow background to signify that the presentation has been watched. When a special icon is the indicator, the icon would appear immediately before or immediately after the title. For example, the highlighted presentation 620 has a flower icon 630 positioned to the right of the title “JAG.” The color of the text could also be used as an indicator. The text normally appears white, but could appear green after at least a portion of the presentation has been watched. For example, in the highlighted presentation 520, the title “JAG”, the date “Thu October 19”, recording time “8:00 pm,” and length “1 hr 0 min” would all appear in green text. Specific text could also be used as the indicator. Text would be placed immediately after the title of the presentation stating “Has Been Viewed” in italics.

In a multi-room environment, a specific icon or specific text could be used as an indicator of when a show on the recorded programs list 610 has been watched. Each user or device in the home could be assigned or choose a different icon or a name. When a remote device, such as 150-1, accesses a program from the recorded programs list and watches at least a potion of the program, the icon assigned to the remote device 150-1 would appear next to the program. Alternatively, the name assigned to the device such as “Kid's Room” could appear next to the program. If a second user or remote device accesses the same program, a different icon will appear next to the first icon. For example, if one member in a household is assigned an icon of a flower and watches the JAG presentation 620, the flower icon 630 will appear next to the title “JAG.” If a second member of the household with an icon of a soccer ball also watches JAG, then the soccer ball icon will appear next to the flower icon 630.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A method for distinguishing first run presentations in an interactive program guide (IPG), said method comprising the steps of presenting an IPG with a plurality of program instances arranged by time and channel and indicating one or more program instances as a first occurrence of said one or more presentations.

2. The method of claim 1, wherein said indicating step comprises presenting a background color for said one or more first occurrences of said presentation which is distinguishable from a background color of subsequent presentations of said one or more presentations.

3. The method of claim 1, wherein said indicating step comprises presenting an icon for said one or more first occurrences of said presentation.

4. The method of claim 1, wherein said indicating step comprises presenting colored text of the title of said one or more first occurrences of said presentation which is distinguishable from a colored text of subsequent presentations of said one or more presentations.

5. The method of claim 1, wherein said indicating step comprises presenting specific text for said one or more first occurrences of said presentation.

6. The method of claim 1, further comprising the step of a user selecting the indicator to be utilized in said program guide.

7. A method for distinguishing first run presentations within a recorded programs list of an interactive program guide (IPG), said method comprising the steps of presenting an IPG with a plurality of program instances arranged by time and channel and indicating one or more program instances as a first occurrence of said one or more presentations.

8. An indicator associated with one or more program instances currently presented in an interactive program guide (IPG) wherein said IPG presents multiple occurrences of at least some of said program instances and said indicator indicates said one or more program instances are a first occurrence of said one or more program instances.

9. In an interactive program guide providing a plurality of program instances wherein at least a portion of said plurality of program instances are first run program instances, a list of said first run program instances accessible from said IPG.

10. The programs list of claim 9, wherein said first run programs list excludes program instances categorized in specific categories.

11. A method for distinguishing presentations that have at least been partially viewed from those that have not been viewed, within a recorded programs list of an interactive program guide (IPG), said method comprising the steps of:
providing a primary device of a networked multi-room system (NMS);
providing one or more remote devices of said NMS;
accessing a recorded programs list from an IPG; and
indicating which of one or more program instances in said recorded programs list that at least a portion has been watched.

12. The method of claim 11, wherein said indicating step comprises presenting an icon associated with a specific user in said NMS.

13. The method of claim 11, wherein said indicating step comprises presenting an icon associated with either of said primary device and one of said remote devices.

14. The method of claim 11, wherein said indicating step comprises presenting specific text for said one or more program instances wherein at least a portion has been watched corresponding to a specific user.

15. The method of claim 11, wherein said indicating step comprises presenting specific text for said one or more program instances wherein at least a portion has been watched corresponding with either of said primary device and one of said remote devices.
